(19) United States
(12) Patent Application Publication
(10) Pub. No.: US 2005/0280492 A1
(43) Pub. Date: Dec. 22, 2005

(54) Wound-rotor type transformer and power source utilizing wound-rotor type transformer

(76) Inventor: Kazuo Kohno, Sanbu-gun (JP)

Correspondence Address: WENDEROTH, LIND & PONACK, L.L.P., 2033 K STREET N. W., SUITE 800, WASHINGTON, DC, 20006-1021, US

(21) Appl. No.: 11/122,122

(22) Filed: May 5, 2005

(30) Foreign Application Priority Data
Jun. 21, 2004 (JP) JP2004-182575
Feb. 7, 2005 (JP) JP2005-029912

(51) Int. Cl. H01F 27/02

(52) U.S. Cl. 336/208

(57) ABSTRACT

An object of this invention is to enhance insulating properties between the terminals provided at both terminals of the secondary windings of the wound-rotor type transformer, and to drive the wound-rotor transformer safely, and the primary windings 110, secondary windings M1, M2 are mounted on the bobbins inserted with the bobbins. The terminal base 1 is provided at the side where the high tension terminals of the bobbins 102, 104 are disposed, and The first terminals S1, S2, S3 and S4 connected to the one terminals of the primary windings M1, M2 are mounted on the terminal base 1 at the side where the high tension terminals are disposed. The second terminals A, B connected to the other terminals of the secondary windings M1, M2 mounted on the bobbins 102, 104 are mounted at the side where the rearward low tension terminals are disposed at the side where the high tension terminals of the bobbins 102, 104 at a predetermined distance. The second terminals A, B are used as the ground terminals. The power source device is constructed to drive the lamps such as the cold cathode type fluorescent lamps with the high tension output at the secondary side of the above-noted wound-rotor type transformer, and the primary windings 110 are connected to the AC signal output circuit, and the second terminals A, B are earthed, and the first terminals S1, S2, S3, S4 are connected to the lamps such as the cold cathode type fluorescent lamps.

### BACKGROUND OF THE INVENTION

This invention relates generally to wound-rotor type transformers for use in inverters such as driving cold cathode type fluorescent lamps and power source devices utilizing the wound-rotor type transformers.

The wound-rotor type transformers generally are such as shown in FIG. 18 that a primary winding P and secondary winding S are wound on a core by means of a bobbin (drawing is omitted), and secondary output terminals T3 and T4 connected to both terminals of the secondary winding S are provided on a terminal base of output sides of primary input terminals T1 and T2 connected to the primary winding P are provided on a terminal base of input side of the transformer, and secondary output terminals T3 and T4 connected to both terminals of the secondary winding S are provided on the terminal base of output sides.

In case where the wound-rotor type transformer is provided on a printed circuit board (PCB), and a discharge type lamp such as cold cathode fluorescent lamp, the wound-rotor type transformer is mounted on the printed circuit board so that its secondary output terminal is opposed to the connector installed on the printed circuit with a shortest distance, and the secondary output side is connected to the lamp through the connector. In case where the output side of the wound-rotor transformer is disposed in opposition to the connector, sufficient insulation becomes required due to a large potential difference between the secondary output terminals connected to both terminals of the secondary winding. For this reason, grooves for insulation are provided on the printed circuit board in order to enlarge the insulation distance between a secondary output terminal at high tension side connected to one end of the secondary winding and a lead wire connected to the secondary output terminal, and between a secondary output terminal connected to the other terminal of the secondary winding and a lead wire connected to the secondary output terminal, whereby an air gap is formed between the secondary output terminals but there are problems such as occurrence of discharge between the secondary output terminals or generation of lead current between both the output terminals that allows the flowing of electric current of high tension over the printed circuit board, and therefore, such arrangements are not necessarily safe measures.

Objects of the present invention are to solve the foregoing problems.

### SUMMARY OF THE INVENTION

The wound-rotor type transformers according to the present invention has a construction that a primary winding and a secondary winding are mounted on the bobbin into which the core is inserted.

The terminal base is provided at the side where a high tension terminal of the bobbin is disposed, and the first terminal connected to one terminal of the secondary winding is mounted on the terminal base at the side where the high tension terminal is disposed. The second terminal connected to the other terminal of the secondary winding mounted on the bobbin is provided at the side where the rearward low tension terminal is disposed which has a predetermined distance from the side where the high tension terminal of the bobbin is disposed. The second terminal is used as a ground terminal. With the construction, the wound-rotor type transformer according to the present invention can be divided to the side where the high tension terminal is disposed and the side where the low tension terminal is disposed so that it elevates insulation characteristics between both the termials of the secondary winding of the wound-rotor type transformer thereby driving the wound-rotor type transformer safely.

Furthermore, the present invention provides a power source device that drives lamps such as the cold cathode type fluorescent lamp with the high tension output at the secondary side of the wound-rotor type transformer, wherein the primary winding is connected to an AC output circuit, and the second terminal is grounded, and the first terminal is connected to the lamp.

### DESCRIPTION OF DRAWINGS

FIG. 1 is an explanatory drawing illustrating the structure wherein a part of the wound-rotor type transformer is omitted.

FIG. 2 is an explanatory drawing illustrating a decomposed external appearance which resembles the above-noted drawing.

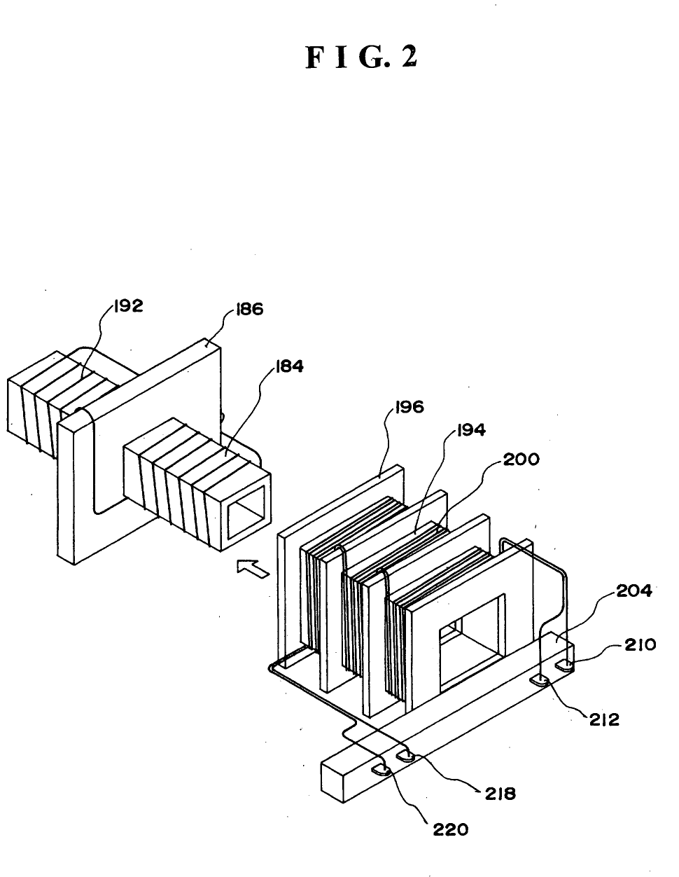

FIG. 3 is a block circuit diagram of the power source device according to this invention.

FIG. 4 is an explanatory drawing illustrating the another embodiment of this invention.

FIG. 5 is an external explanatory drawing of the bobbin of the wound-rotor type transformer.

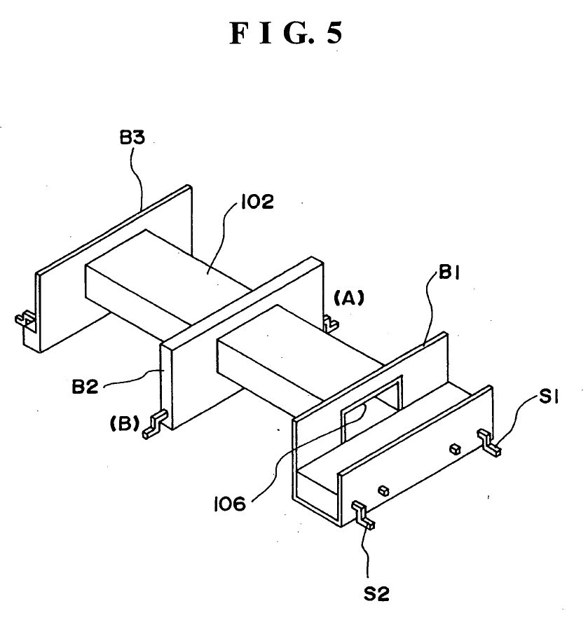

FIG. 6 is an explanatory drawing of the wound-rotor type transformer.

FIG. 7 is a circuit diagram of the wound-rotor type transformer.

FIG. 8 is a block diagram illustrating the other embodiment of this invention.

FIG. 9 is a block diagram illustrating the other embodiment of this invention.

FIG. 10 is a block diagram illustrating the other embodiment of this invention.

FIG. 11 is a block diagram illustrating the other embodiment of this invention.

FIG. 12 is a block diagram illustrating the other embodiment of this invention.

FIG. 13 is a cross section illustrating the other embodiment of the wound-rotor type transformer.

FIG. 14 is an explanatory drawing illustrating the other embodiment of this invention.

FIG. 15 is a circuit explanatory drawing illustrating the other embodiment of this invention.

FIG. 16 is an explanatory drawing illustrating the other embodiment of this invention.

FIG. 17 is a circuit explanatory drawing illustrating the other embodiment of this invention.

FIG. 18 is an explanatory drawing of the structure of a typical prior art technology.

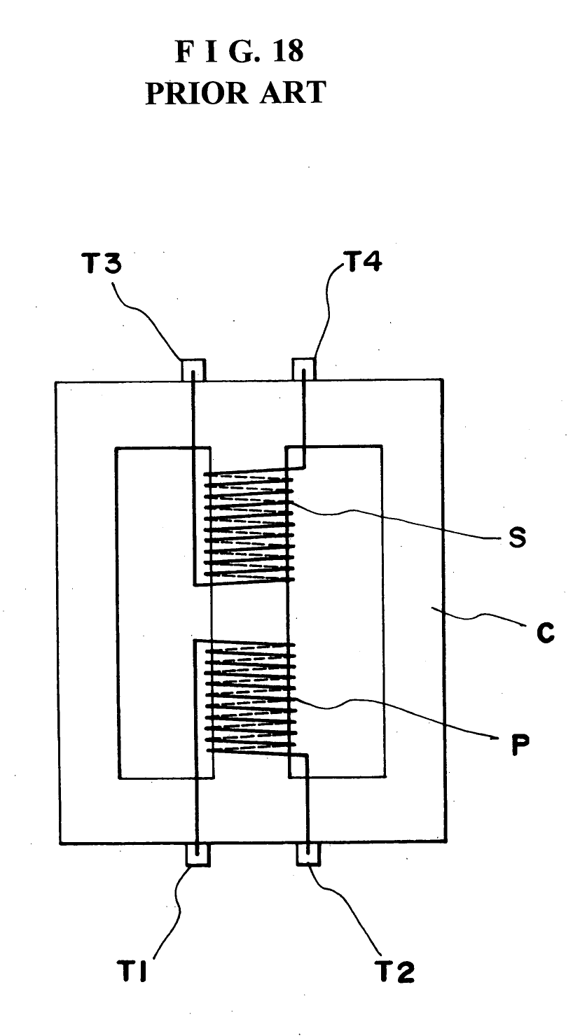

### DETAILED DESCRIPTION OF THE INVENTION

Hereinbelow a detailed description of the invention is provided by referring to the attached drawings illustrating the mode of its embodiment.

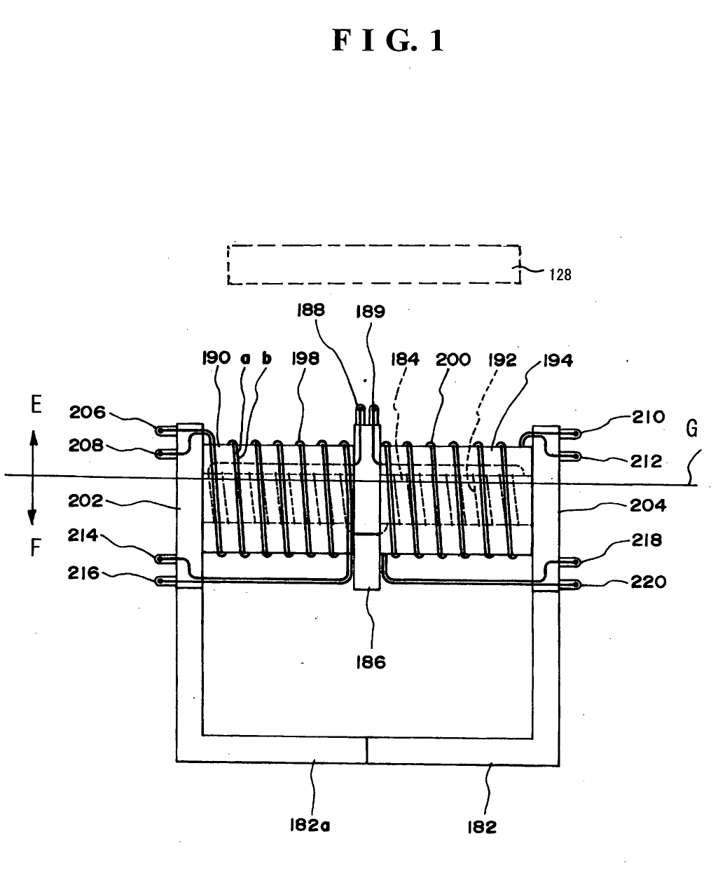

In FIG. 1, numeral 182 denotes a core constituting a square type frame core formed by joining two pieces of [shape and] shape.

A primary bobbin 184 is inserted into the part of the parallel portion of the core 182. A terminal base 186 is fixed to the center of the primary bobbin 184, and primary terminals 188, 189 are provided on the terminal base 186. A primary winding 192 is mounted on the bobbin 184, and the primary input terminals 188, 190 are connected to both terminals of the primary winding 192 by means of the lead wire.

A pair of the secondary bobbins 191, 194 are inserted into the outside of the primary bobbin 184 which are positioned at both sides of the terminal base 186. A partition 196 of each end of the pair of the secondary bobbins 191, 194 contacts each face of both sides of the terminal base 186. In FIG. 1, the partition 196 of the secondary bobbins 191, 194 is omitted from the drawing to avoid complication of illustration. On the secondary bobbins 191, 194, secondary windings 198, 200 are wound by two pieces of twofold wires a, b. Start winding terminals of the secondary windings 198, 200 consisting of twofold wires are connected to secondary high tension terminals 206, 208, 210, 212 provided on each terminal base 202, 204 of the respective terminal bases 202, 204 of the secondary bobbins 191, 194 by means of the lead wire, and the finish winding terminals are connected to the ground terminals 214, 216, 218, 220 by means of the lead wire.

The secondary windings 198 and 200 are wound mutually in counter direction as shown in FIG. 1, and the number of windings are mutually identical. When the wound-rotor type transformer is disposed on the printed circuit board (drawing is omitted), the terminals 206, 208, 210 and 212 are disposed at the side (the side where the high tension terminal is disposed) facing the connector 128 connected to the lamp such as the cold cathode type fluorescent lamp that is disposed on the printed circuit board at the shortest distance. Furthermore, the secondary windings 214, 216, 218, 220 are disposed at the side where the low tension terminal of the rearward at a predetermined distance relative to the side where the high tension terminal is disposed. With the foregoing arrangement of the secoondary terminals, the wound-rotor type transformer is divided into the high tension region E in the upper side in FIG. 1 on the basis of the line G, and into the low tension region F in the lower side. The secondary terminals 206, 208 and the secondary terminals 210, 212 are mutually in counter phase, and the terminals are in such a relationship that when the one part is the plus, the another part is the minus. Of course, the secondary terminals 206, 208 and the secondary terminals 210, 212 may be mutually in identical phase.

In the foregoing construction, the relationship between the primary winding 192 and the secondary windings 198, 200 is such that in the double layer structure of the bobbins, the secondary windings 198, 200 are disposed at both sides of the primary winding that enables to form the multiple output by such a simple structure.

In this embodiment, the high tension may be applied to the twofold parallel windings constituting the secondary windings but since this high tension is mutually at the identical potential, there is no chance of short circuiting between the parallel secondary windings or the leakage of electric current. Furthermore, the other parallel portion 182a of the core 182 can be formed in similar form, and in case where the core 182 is made of the structure of the bivertical symmetry in FIG. 1, the primary sides are connected serially or in parallel to form one input, and 8 outputs can be materialized. Furthermore, in case the number of windings of the secondary windings is set to be 3 pieces or 4 pieces whereby further multiple outputs can be materialized.

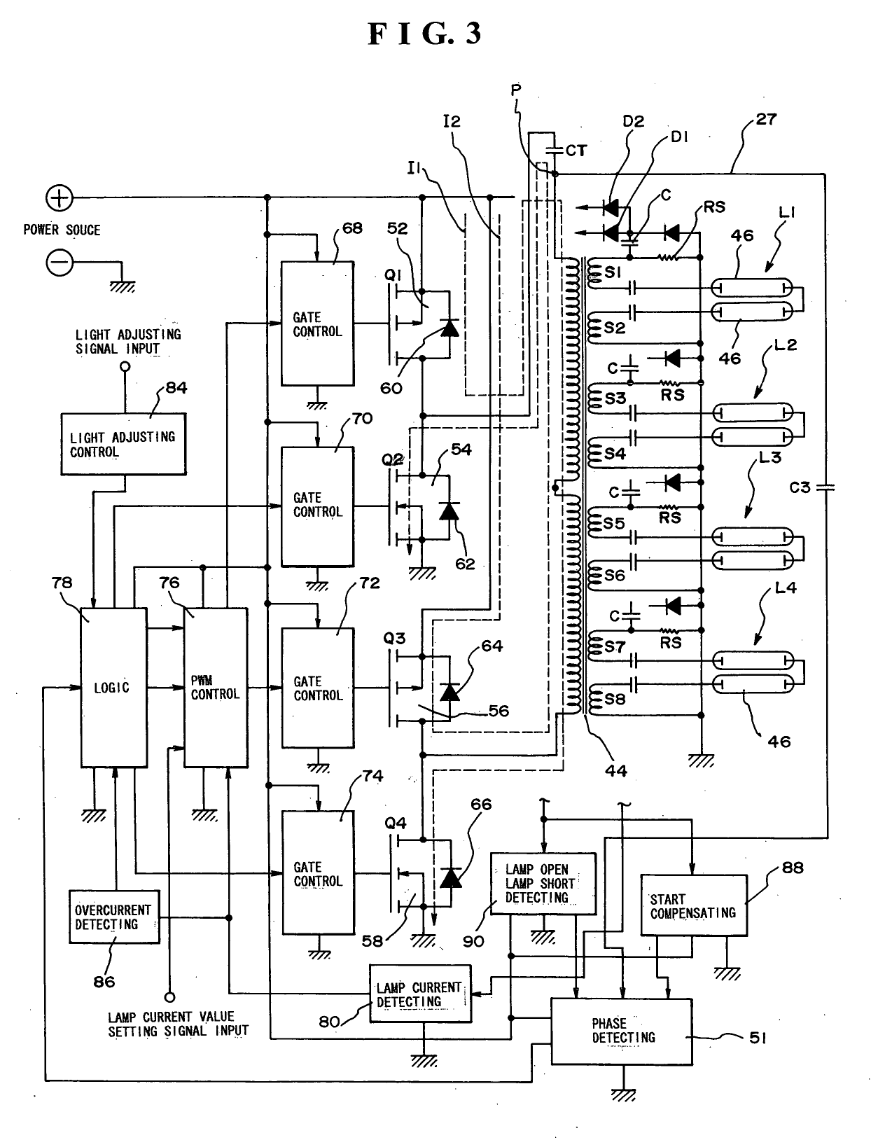

The multiple output-type winding transformer 4 of the foregoing embodiment as shown in FIG. 1 is operated by a self-excited oscillation circuit as shown in FIG. 3. In case of forming the winding transformer of the multiple output structure, there is no particular limit to the double layer structure of the bobbins, and the parallel winding of the secondary windings on the bobbin of the conventional structure to constitute the multiple output type wound-rotor type transformer.

Now, the power source device for driving a 1 input 8 output type winding transformer with full bridge type self-excited oscillation circuit is described in the following by referring to FIG. 3.

In FIG. 3, numeral 52, 54, 56, 58 denote switching elements consisting of EFT, and commutation diodes 60, 62, 64, 66 are connected between the source and drain of each switching element. Gate control circuits 68, 70, 72, 74 are connected to each gate of the switching elements 52, 54, 56, 58 and among them, a PWM control circuit 76 is connected to the gate control circuits 68, 72, and the gate control circuits 70, 74 are connected to a logic circuit 78. The PWM control circuit 76 controls a conductance angle of the switching elements 52, 56 so that it receives signals from a lamp current detecting circuit 80 that detects electric current flowing in the lamp 46 and a level of this signal becomes a set value given by the line 82.

Numeral 44 denotes a wound-rotor type transformer of 1 input 8 output type fixed to the circuit-board (drawing is omitted), and 4 pairs of pair lamps L1, L2, L3, L4 to which 2 pieces of cold cathode type fluorescent lamps 46 are connected in series are disposed at the output side of the transformer. Each terminal of the lamp pairs L1, L2, L3, L4 is respectively connected to high tension terminal side of a pair of the secondary side windings corresponding to the winding type transformer 44. Each terminal of the secondary side windings S1, S3, S5, S7 is earthed by means of respective current detecting resistors RS, and the secondary side windings S2, S4, S6, S8 are earthed by means of the lead wires. Each terminal of each resistor RS is connected to a lamp current detecting circuit by means of a capacitor C and a diode D1 for rectification.

A phase detecting circuit 51 is connected to a middle point P of an LC series resonance circuit by means of the lead wire 27. A logic circuit 78 is constructed to create signals for turning the switching element ON and OFF on the basis of resonance phase signals at primary side from the phase detecting circuit 51 connected to the lead wire 27 and transmits on-off control signals to the gate control circuits 68, 72 by means of the PWM control circuit 76 and transmits the on-off control signals to the gate control circuit 70, 74. The phase detecting circuit 51 transmits corrected phase signals delayed by 90 degrees from the phase voltage signals of the middle point P of the LC series resonance circuit to the logic circuit 78. The signals become an identical phase with the electric current flowing in the LC series resonance circuit at primary side. The voltage of the terminal at the primary side of the transformer 44 further lowers after exceeding the OV upon the passing of the phase time of 90 degrees electrically even if the charge voltage of the capacitor CT reaches the DC power source voltage, and moreover, it becomes a maximum value of the minus upon passage of the phase time of 90 degrees.

At this time, the signals delayed by 90 degrees from this voltage becomes the OV so that the switching control signals are turned ON and OFF with this timing. The logic circuit 78 outputs the switching control signals alterately as described hereinabove. The logic circuit 78 creates photo-adjusting control signals on the basis of output signals of a photo-adjusting control circuit 84 to which the photo-adjusting control signals are inputted, and the burst control of the ON-OFF of the switching element and the control of the switch-on-pulse width of the PWM control circuit 76 are carried out by the photo-adjusting control signals whereby the brightness of the lamps 46, 46 is contstantly maintained, and the brightness is to be optionally set from the brightness zero to 100% according to the photo-adjusting signals. Furthermore, an overcurrent detecting circuit 88 is connected to the logic circuit, and when the overcurrent flows in the lamp 20, the logic circuit 78 detects it, and prevents the flow of the overcurrent by feeding the signals preventing the overcurrent to the PWM control circuit 76.

A starting compensation circuit 88 are connected to shunt resistors RS of an energizing circuit of the lamp 46, thereby the current signals of each pair of the lamps are inputted to the circuit 88. The starting compensation circuit 88 inputs the starting compensation signals to the phase detecting circuit 51 to positively start the self-excited oscillation circuit when the power source is ON, off. The phase detecting circuit 51 outputs starting signals for self-excited oscillation to the logic circuit 78 upon receiving the starting compensation signals. The starting compensation circuit 88 is so set that the lamp does not start the discharge even if the electric current flows in the predetermined direction determined by the logic to the primary side of the transformer after the signals whose phase is corrected enters into the logic circuit 78 from the phase detecting circuit 51. The starting compensation circuit 88 is provided for the starting compensation of such a case. In this case, in order to positively light up the lamp 46, the starting compensation circuit 88 judges if the lamp 46 is lighted ON or not by detecting the electric current flowing in the lamp 46, and in case, the lamp is not lighted ON, transmits the starting compensation signals to the phase detecting circuit 51 until the lamp is lighted ON.

The phase detecting circuit 51 receives the starting compensation signals and outputs the starting signals to the logic circuit 78 until the lamp 46 is lighted ON. At the photo-adjusting control circuit 84, the voltage of the photo-adjusting signals is compared with the output voltage of a triangular wave oscillation circuit built in the control circuit 84 and generates burst photo-adjusting signals of a predetermined period. The circuit 84 turns ON and OFF the entire logic signals and as a result, controls the brightness. This method makes the adjustment freely from the light-OFF to the total light-ON, but since the lamp 46 is turned ON and OFF with a period of the photo-adjusting signals, it becomes necessary to make a confirmation of starting and positive starting for each period. For this reason, the starting compensation circuit 88, as described in the foregoing, in order to materialize the positive light-on, transmits the starting compensation signals to the phase detecting circuit 51 in the beginning. To explain the operation of the starting compensation, at the time of turning the power source ON for the first time or the lamp is not lighted ON, for example, the switching elements 52, 58 are turned ON with a predetermined pulse width so that the electric current flows in the direction 11.

With the foregoing arrangement, the electric current flows to the primary windings of the capacitor CT and the transformer 44, and the signals are transmitted to the phase detecting circuit 51 through the lead wire 27, and the electric current flows mutually to I2, I1, I2, I1, and the self-excited oscillation circuit starts the oscillation with the detected resonance frequency. The starting compensation circuit 88 forms an initial period reset. If the lamp is lighted on, it performs the resetting again, and transmits the initial starting signals to the logic circuit 78 through the phase detecting circuit 51. A lamp open circuit 90 is constructed in such a way that it is connected to each shunt resistor RS at the secondary side of the wound-rotor type transformer 44, and detects the electric current of the lamp at the secondary side. When the lamp 46 is out of order and the lamp current does not flow, namely, the state of the lamp open, transmits the signals to the logic circuit 78, and shuts out the control circuit consisting of the logic circuit 78, PWM control circuit 76 and gate control circuits 68, 70, 72, 74. The overcurrent detecting circuit 86 transmits the signals to the logic circuit 78 when the PWM control circuit is in trouble or the wiring of the lamp 46 is shortcircuited to shuts out the control circuit.

In the foregoing construction, when the power source is switched ON, and the ON signals are instantly supplied to either of the gate control circuits 68, 74 or 72, 70 from the PWM control circuit 76 and the logic circuit 78, the electric current of the DC power source flows to the primary side winding of the wound-rotor type transformer 10 through the switching elements 52, 58 in the direction of I1 or through the switching elements 56, 54 in the direction of I2. With the energization of the primary winding, it starts the self-excited oscillastion circuit and the wound-rotor type transformer 44 ganerates the resonance voltage. The frequency of the resonance voltage at the primary side of the wound-rotor type transformer 44 is supplied to the phase detecting circuit 51 by the lead wire 27. The logic circuit 78 and the PWM control circuit 76 drive the gate control circuits 68, 70, 72, 74 on the basis of the phase signals from the phase detecting circuit 51, and performs the ON and OFF control of the switching elements 52, 54, 56, 58.

The electric current flows alternately in the directions of I1 and I2 by the ON and OFF of the switching elements 52, 54, 56, 58, and the self-excited oscillation circuit performs the self-excited oscillation with the resonance frequency at the primary side of the wound-rotor type transformer 10. At electrodes at each both terminals of each pair of the lamps L1, L2, L3, L4, an unevenness in the brightness of the lamp does not appear because of the application of the high tension to the windings of the secondary side of the transformer. As described in the foregoing, the embodiment of this invention provides the resonance voltage higher than the input power source voltage at the primary side of the wound-rotor type transformer whereby it allows the saving of number of windings at the secondary side of the wound-rotor type transformer and provides a margin of the spaces for the windings at the secondary side. On the benefit of the increased space, it becomes possible to make two pieces or more pieces of parallel windings, and as a result, multiple output can be materialized. For this reason, the wound-rotor type transformer to be used in this invention can be transformed into the wound-rotor type transformer of 1 input multiple output type with the size almost same with the regular 1 input 1 output type wound-rotor type transformer.

Other embodiments of the present invention will be described in the following.

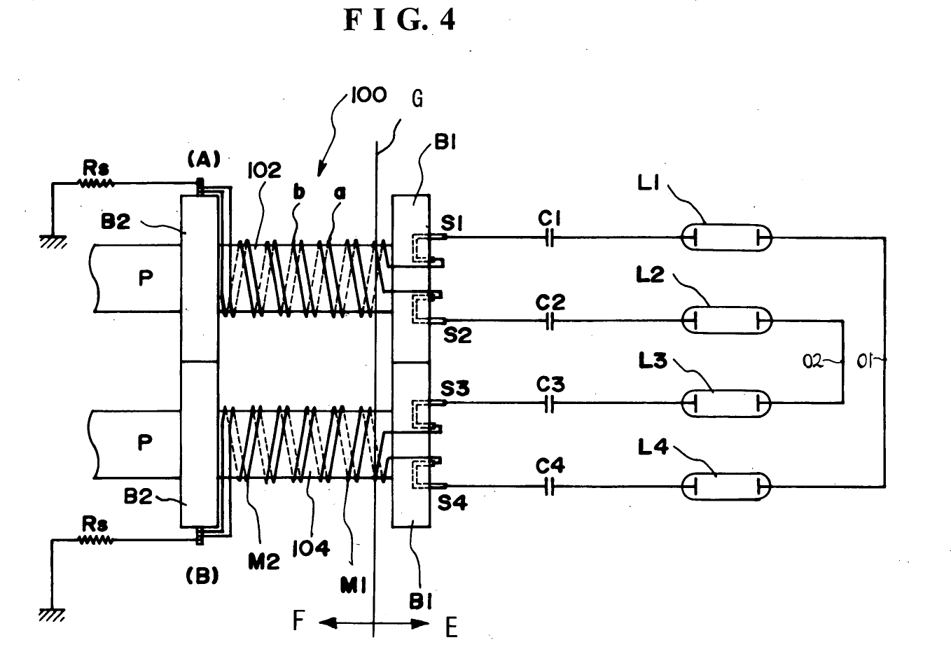

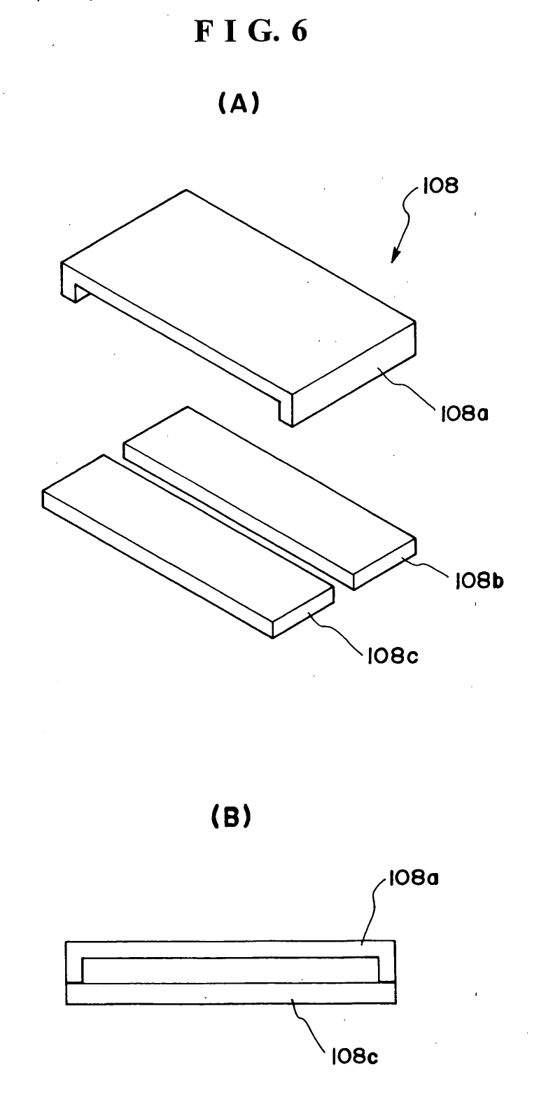

In FIG. 4, a transformer 100 is provided with a pair of bobbins 102, 104 formed by joining mutually in parallel, and secondary windings M1, M2 are mutually wound in mutually counter directions with mutually the same number of windings by means of two pieces of twofold wires a, b between terminal bases B1, B2 of the bobbins 102, 104 respectively. A common core 108 is inserted and disposed in a hole 106 of said pair of the bobbins 102, 104. The core 108, as shown in FIG. 6, consists of I type core 108b and 108c, and a coupled core 108a connected to the cores and forming a closed magnetic path.

An end of winding start side (high tension side) of the secondary windings M1, M2 are connected to the terminals S1, S2, S3, S4 of the terminal base B1, and an end of winding finish side (low tension side) of the respective secondary windings M1, M2 are connected to the terminal A of the terminal base B2 of the bobbin 102 and the terminal B of the terminal base B2 of the bobbin 104. Between the terminal bases B2, b3 of the bobbins 102, 104, the primary winding 110 is wound. Any optional constructions such as a construction wherein the primary winding 110 is wound between the terminal bases B2, B3 of the bobbins 102, 103, and they are connected in series or parallel, or a singular construction wherein windings are applied over across the bobbins 102, 104 can be employed. The primary winding 110 is connected to the output side of the inverter circuit such as fullbridge type self-excited oscillation circuit as shown in FIG. 3 or the like.

Two pieces of lamps L1, L4 consisting of mutually and serially connected CCFL (cold cathode fluorescent type lamp) are disposed between the terminals of counter phase, and the terminal S1 is connected to the one electrode of one lamp L1 by means of the ballast capacitor C1, and the terminal

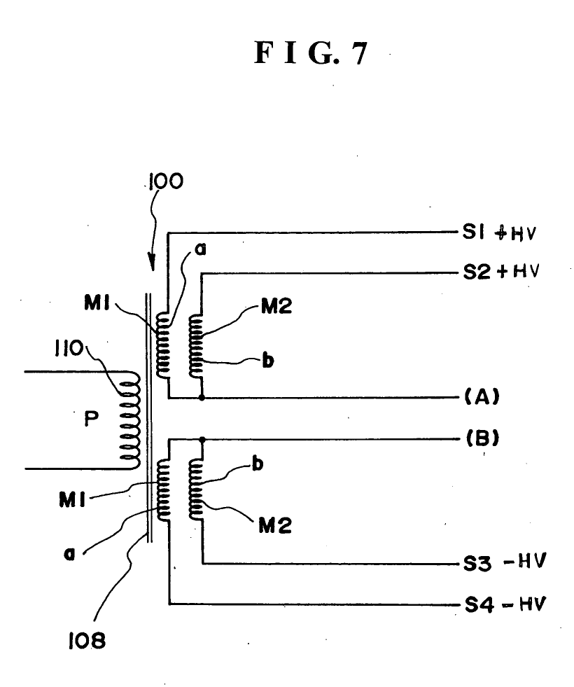

S4 is connected to the one electrode of the other lamp L4 by means of the ballast capacitor C4. The terminal A is earthed by means of the resistor Rs, ad the terminal B is similarly earthed by means of the resistor Rs. FIG. 7 illustrates the easy understanding of the circuit of FIG. 4. When the alternating current is supplied to the primary winding 110 of the transformer 100 from self-excited oscillation circuit, the high tension voltage is generated at the secondary side of the transformer 100.

The high tension+HV of the terminals S1, S2 ad the high tension−HV of the terminals S3, S4 are in mutually counter phase relationship, and the high tension is applied to the lamps L1, L4 and the L2, L3 by the secondary side of the transformer. The connecting point 01 of the lamps L1, L4 and the connecting point 02 of the lamps L2, L3 become the zero point from the dummy point of view.

When the transformer 100 is driven, the electric current flows in a circle from the terminal A of the one bobbin 102, passing through the secondary winding M1 of the one bobbin 102, and passing through the terminal S1, the ballast capacitor C1, the lamp L1, the lamp L4, the capacitor C4, the terminal S4, the secondary winding M1 of the other bobbin 104, the terminal B, and passing through the ground and reaching the terminal A. Similarly, the electric current flows in a circle from the terminal A of the one bobbin 102, passing through the secondary winding M2 of the one bobbin 102, the terminal S2, the ballast capacitor C2, the lamp L2, the lamp L3, the capacitor C3, the terminal S3, the secondary winding M2 of the other bobbin 104, and the terminal B and passing through the ground and reaching the terminal A.

The magnitude of the lamp current of the lamps L1, L2, L3, L4 becomes a uniform by the electric current flowing in the loop. The electric current flowing in the secondary windings M1, M2 of the bobbin 102 and the secondary windings M1, M2 of the bobbin 104 are on the identical core so that the electric current flowing in the secondary windings M1, M2 of the bobbin 102 performs the diverting action, namely, the electric current balancing action. In the secondary windings M1, M2 of the bobbin 104, the similar diverting action (electric current balancing action) is automatically made, and finally, each electric current flowing through 4 pieces of the lamps L1-L4 become the same. The transformer 100 denoted in FIG. 4 is provided on the printed circuit board and the terminal base B1 at the side facing connector (drawing is omitted) connected to the lamps L1-L4 is disposed at the side where the high tension terminal is installed, and the terminal base B2 is disposed rearward at a predetermined distance against the side where the high tension terminal is disposed, and the right side is divided to the high tension region E and the left side is divided to the low tension region F on the basis of the line G. For reference, a pair of the cold cathode type fluorescent lamps that are serially connected may be formed in a piece of long cold cathode type fluorescent lamp of curved U-form, for example, like lamps L1, L4, L2, L3 in FIG. 4 which are displayed in the foregoing embodiment and embodiments to be described hereinafter. Furthermore, this invention is not particularly limited to the embodiment of counter phase of the terminals S3, S4 against the terminals S1, S2, and it may be the identical phase.

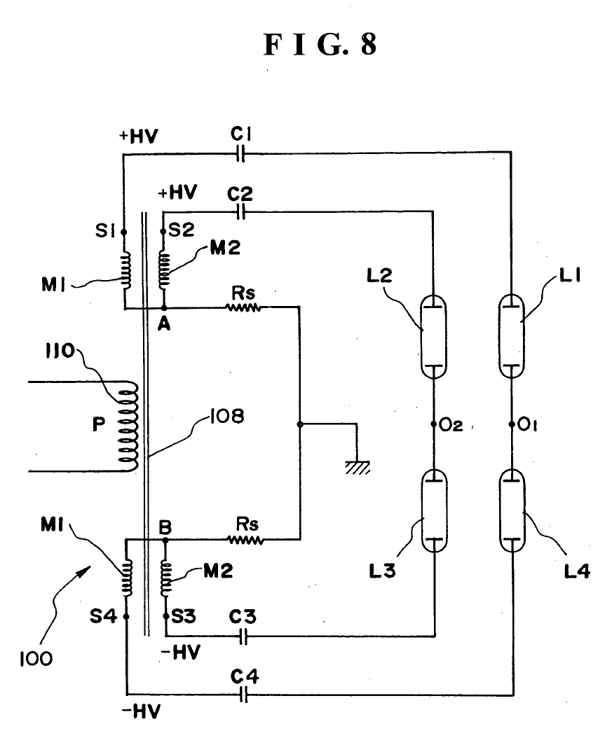

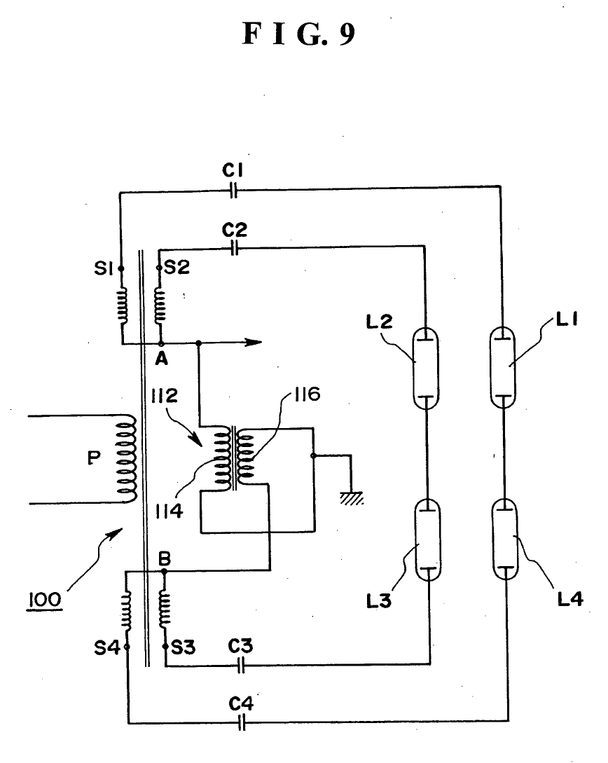

FIG. 9 illustrates that a shunt transformer (electric current balancer) 112 is disposed between the terminals A and B, and the terminal A is connected to one terminal of the winding 114 of one part of the shunt transformer 112, and the other terminal of the winding 114 is earthed, and the terminal B is connected to the other terminal of the winding 116 of the other part of the shunt transformer 112, and the one terminal of the winding 116 is earthed. Other constructions of FIG. 9 are identical with the circuit illustrated in FIG. 8.

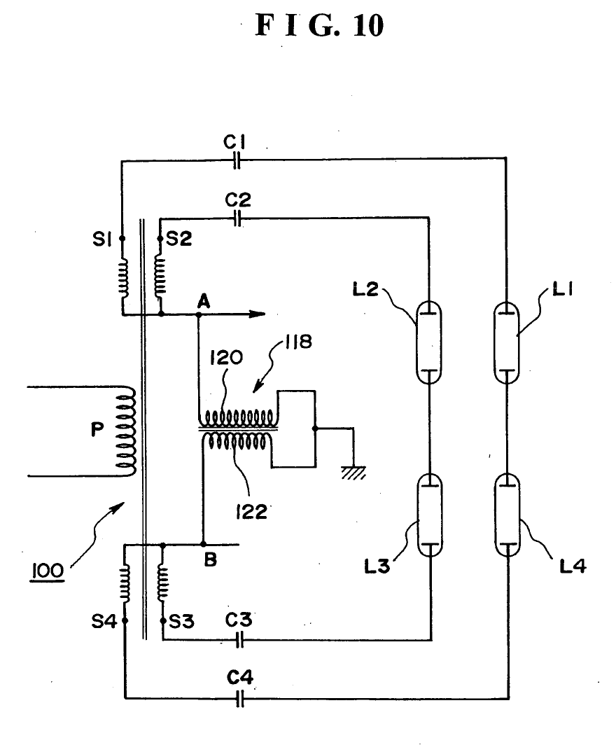

With this construction, the lamp electric current of the lamps L1, L2, L3, L4 are arranged to be made more uniform. FIG. 10 illustrates that the terminals A, B are connected to one terminal of each winding 120, 122 of the shunt transformer 118, and the other terminals of each winding 120, 122 of the shunt transformer 118 are made to be a uniform terminal that is connected to the ground. With this connection, the similar effect can be obtained as discussed with respect to FIG. 9, and the detection of the lamp electric current as well as the detection of the final drop voltage from the shunt resistor of the winding of the transformer 100 become feasible. In the embodiment, the number of the line (wire) of the parallel winding of the secondary windings is not limited to 2 pieces, and it is possible to make the wire to be multiple pieces, and to be the parallel winding, and also, the series connection of the lamps is not limited to 2 pieces, and more than 3 pieces may be connected in series.

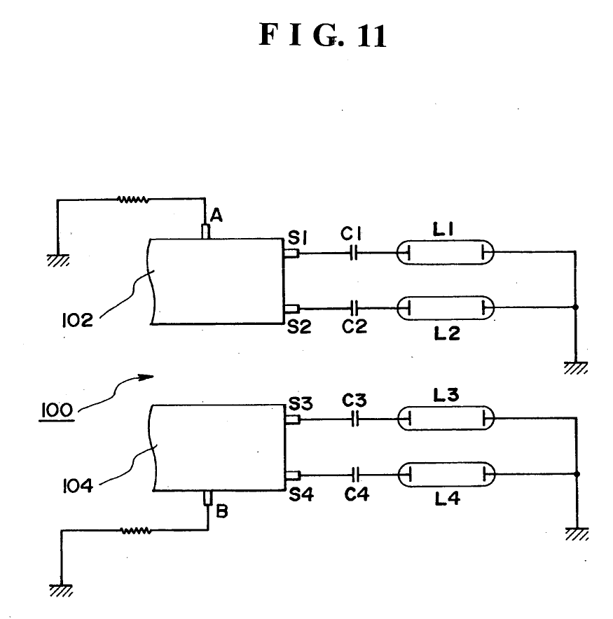

In this embodiment, the construction is illustrated wherein 2 pieces of the bobbins are used, and as shown in FIG. 4, 4 pieces of the secondary windings M1, M2 are provided, and 2 pieces of the primary windings and 4 pieces of the lamps are provided, but as shown in FIG. 11, it is feasible to form the construction wherein 2 pieces of the secondary windings ad one piece of the primary winding and 2 pieces of the lamps are provided. In FIG. 11, the construction of the transformer 100 is identical with the construction of the transformer 100 illustrated in FIG. 4. By the way, it is feasible to form the construction of the transformer 100 consisting of 2 pieces of the transformers independent for each of the bobbins 102, 104. Each transformer is formed wherein the primary winding 100 is provided for each of bobbins 102, 104, and each primary winding 110 is connected in series or in parallel. Two pieces of the lamps L1, L2 are mutually and serially connected, and the one electrode of the one lamp is connected to the terminal S1 by means of the ballast capacitor C1, and the other electrode of the other lamp L2 is connected to the terminal S2 by means of the ballast capacitor C2. The other electrodes of 2 pieces of the lamps L1, L2 are connected to the ground. The connection of the lamps L3, L4 is identical with the foregoing construction.

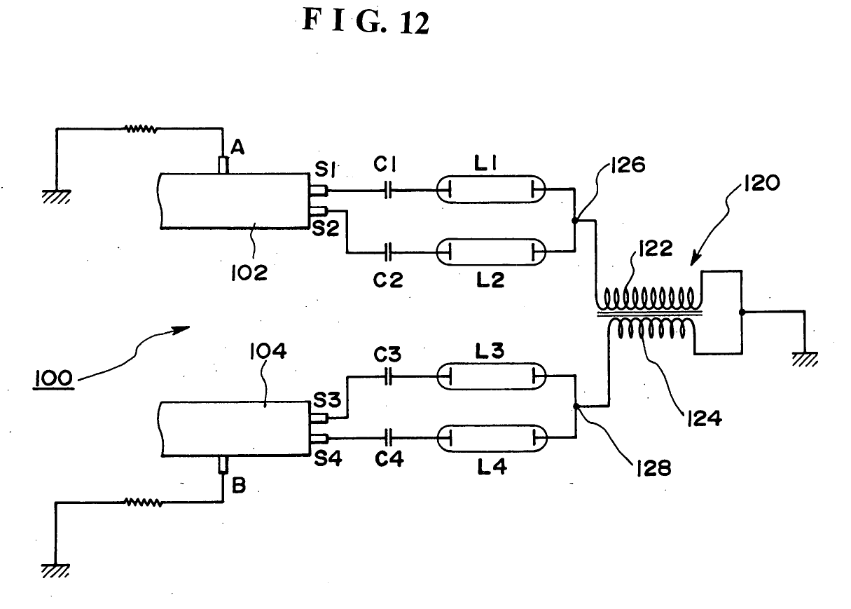

Even with the foregoing construction, the effect same with the embodiment as illustrated in FIG. 4 is obtained but a minor degree of unevenness in the brightness of the lamps appears with respect to each group of the secondary windings of the transformer 100. In this embodiment, the brightness of the lamps L1, L2 are equal, and the brightness of the lamps L3, L4 are equal. The unevenness of the brightness with respect to the lamp groups can be eliminated by adding the shunt transformer 120 as shown in FIG. 12.

Each terminal of the windings 122, 124 of the shunt transformer 120 is connected to a common connecting point 126 of the lamps L1, L2 and a common connecting point 128 of the lamps L3, L4, and each other terminal of the windings 122, 124 is connected to the ground. The electrodes of the lamps L1, L2 are connected to the terminals S1, S2 of the transformer 100 by means of the ballast capacitors C1, C2, and the electrodes of the lamps L3, L4 are connected to the terminals S3, S4 of the transformer 100 by means of the respective ballast capacitors C3, C4. The other construction is identical with the construction illustrated in FIG. 4. The windings 122, 124 of the shunt transformer (electric current balancer) 120 are wound mutually in counter phase, and the the operation is carried out so that magnitude of the electric current flowing in the windings 122, 124 becomes identical, and the lamp electric current flowing in the lamps L1, L2, L3, L4 become uniform by the shunt operation (electric current balancing operation) of this transformer.

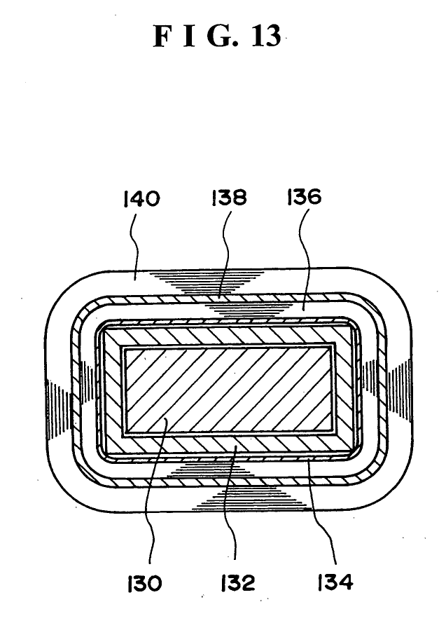

FIG. 13 illustrates the another embodiment of the parallel winding of the wires in the transformer. The first secondary winding 136 is laminated and is wound on the bobbin 132 with built-in core 130 by means of an insulator member 134, and the second secondary winding 140 is laminated and is wound with the same number of windings with the first secondary winding 136 by means of the insulator material over the first secondary winding 136, and the first and the second secondary windings 136, 140 corresponding to the 2 pieces of the windings a, b shown in FIG. 4 may be formed in a lamination structure. For reference, the foregoing secondary windings 136 may be formed in bifilar winding consisting of more than 2 pieces of the windings, and similarly, the second secondary windings 140 may be formed in bifilar winding consisting of more than 2 pieces of the windings. In FIG. 13, in case of forming the first and second secondary winding 136, 140 with more than 2 pieces of the wires, 1 input 4 output winding type transformer can be constructed.

Other embodiments of this invention will be described in the following.

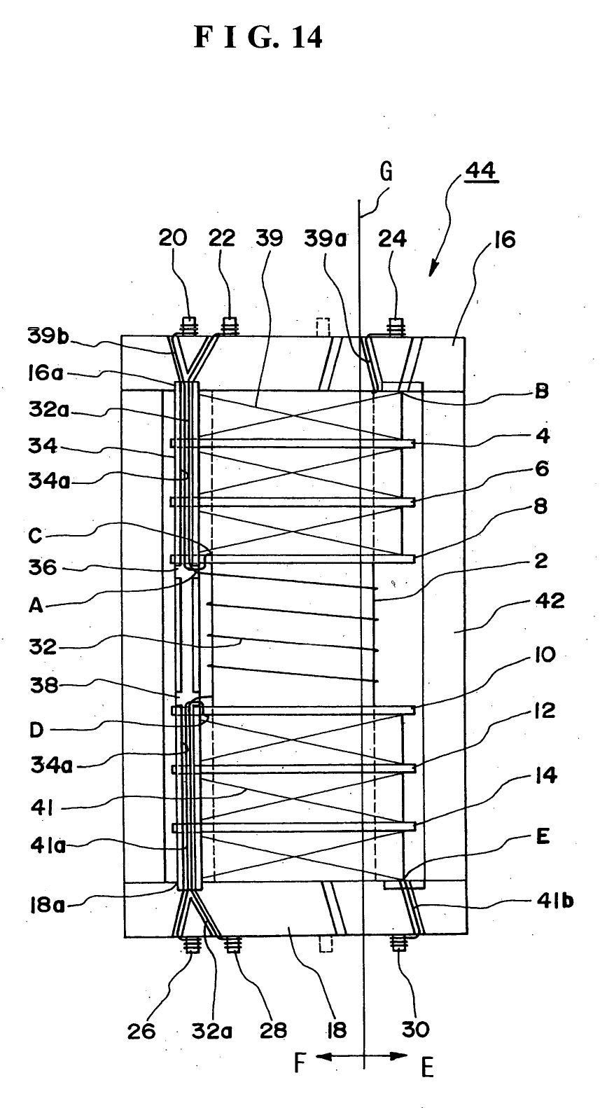

In FIG. 14, numeral 2 is a bobbin (insulator member) of a wound-rotor type transformer, and a plurality of plate type partitions 4, 6, 8, 10, 12, 14 of square shape with insulative pressure resistance are fixed to its angular cylindrical portion at a predetermined interval, and a concave portion for winding is formed on the bobbin (insulator member). Terminal bases 16, 18 extending in right angular direction relative to axial direction of the bobbin (insulator member) are fixed to both ends of the bobbin (insulator member) 2 in its axial direction, and the terminals 20, 22, 24, 26, 28, 30 are fixed to the terminal bases. Among the foregoing terminals, the terminals 24, 30 are disposed at high tension side of the transformer at the right side of the line G, and the terminals 20, 22, 26, 28 are disposed at low tension side at the left side of the line G.

The secondary high tension terminal 24 is disposed at one side of the terminal base 16 at one end side of the bobbin (insulator member) 2, and the primary input terminal 22 and the secondary ground terminal 20 are disposed at the other side. The primary input terminal 22 and the ground terminal 20 are disposed at the other side of the terminal base 16 which is separate as much as possible in order not to be influenced with the high tension of the secondary high tension terminal 24. The secondary high tension terminal 30 is disposed at one side of the terminal base 18 at the other end side of the bobbin (insulator member) 2, and the primary input terminal 28 and the secondary ground terminal 26 are disposed at the other side which is far separated as much as possible therefrom. An insulator member of elongate type insulation material is mounted between guide mounting grooves 16a, 18a formed at the fitting sides of the terminals 20, 22 and 26, 28 of the terminal bases 16, 18, and the concave portion 34b of the insulator member 34 is fitted into the outer edges of the corresponding partitions 4, 6, 8, 10, 12, 14. The insulator member 34 is provided with a lead wire guide portion 34a formed with an open groove at the side opposite to the side facing the bobbin (insulator member) 2 along its longitudinal direction.

The primary winding 32 is wound, for example, in clockwise direction with its one end side as the start winding in the concave portion surrounded by the partitions 8, 10 in the center of the bobbin (insulator member) 2. A lead wire 32a at the start winding side A of the primary winding 32 is disposed in the guide portion 34a of the lead wire of the insulator member 34 through a hole 36 formed on the insulator member 34, and is led to one end side of the bobbin (insulator member 1) 2 passing through the lead wire guide portion 34a and is connected to the primary side input terminal 22 by means of the guide groove formed on the terminal base 16. The lead wire 32a of the finish end side of the primary winding 32 is disposed in the lead wire guide portion 34a of the insulator member 34 through a hole 38 formed on the insulator member 34, and is led to the other end side of the bobbin (insulator member) 2 through the lead wire guide portion 34a, and is connected to the input side input terminal 28 by means of the guide groove formed on the terminal base 18. The first primary winding 39 is sequentially wound with clockwise winding in each concave portion between the terminal base 16 and the partition 4, and between the partitions 4, 6 and between the partitions 6, 8 at one side of the primary winding 32 on the bobbin (insulator member) 2 with the one end side B of the bobbin (insulator member) 2 as the winding start.

The reason for dividing the middle portion of the secondary winding 39 with a plurality of the partitions 4, 6, 8 is taken into consideration for the insulation pressure of the secondary winding 39. A lead wire 39a at the winding start of the first secondary winding 39 is led to the secondary high tension terminal 24 through a groove formed on the terminal base 16, and is connected to the terminal. A lead wire 39b at the finish end side C of the first secondary winding 39 is disposed inside of the lead wire guide portion 34a of the insulator member 34 by means of a hole 36, and passing through the lead wire guide portion 34a along with the lead wire 32a, and is led to one end side of the bobbin (insulator member) 2, and is connected to the ground terminal 20 at the secondary side by means of the guide groove formed on the terminal base 16. The second secondary winding 41 is sequentially wound with clockwise winding in each concave portion between the partitions 10, 12 and between the partitions 12, 14 and between the partitions 14, terminal base 18 with the side D in contact with the partition 10 as the winding start at the other side of the primary winding 32 in the center of the bobbin (insulator member) 2.

The first and second secondary windings 39, 41 disposed in symmetry at the right and left of the primary winding 32 are of identical construction. The lead wire 41b of the finish end side E of the second secondary winding 41 is led to the secondary high tension terminal 30 passing through the groove formed on the terminal base 18 and is connected to the terminal. The lead wire 41a at the winding start end side D of the second secondary winding 41 is disposed in the lead wire guide portion 34a of the insulator member 34 by means of the hole 38, and passing through the lead wire guide portion 34a along with the lead wire 32a of the primary winding 32 and is led to the other end side of the bobbin (insulator member) 2 and is connected to the secondary side ground terminal 26 by means of the guide groove formed on the terminal base 18. As will be obvious from the foregoing winding structure, both terminals of the primary winding 32 between the partitions 8, 10 come to contact with the low voltage ground side of the secondary windings 39, 41 whereby the difference between the voltage of the primary winding 35 and the voltage of the secondary windings 39, 41 which are adjacent windings becomes smaller.

For this reason, a simple structure can be formed with respect to the insulation pressure resistance structure between the primary winding 32 and the secondary windings 39, 41. Even if, namely, the primary winding and the lead wire at the secondary ground side are disposed in parallel in the common lead wire guide portion 34a as there is small potential difference between the primary winding 32 and the ground side of the secondary windings 39, 41, no problem arises with respect to the insulation pressure resistance. For reference, a plurality of lead wire guide portions are provided on the insulator member 34, and each piece of the lead wire may be disposed on the lead wire guide portion. Numeral 42 is a core, and 2 pieces of E-shaped cores are joined, and an external edge portion is disposed at the outside of the bobbin (insulator member) 2, and an inside portion 42a of the core 42 is disposed in the cylindrical portion of the bobbin (insulator member) 2. The foregoing wound-rotor type fluorescent lamps 46, 46 of 1 input 2 output construction are driven in a condition which are free of unevenness in brightness by using this transformer. In this case, two pieces of lamps 46, 46 whose both terminals are connected to the high tension side of the secondary windings 39, 41 provide no difference in the brightness at both terminals of the lamps.

The foregoing 1 input 2 output wound-rotor type output transformer 44 of a type that has a mutual counter phase relationship of the terminals, and it is preferable to operate that at the primary side of this transformer, a series or parallel resonance circuit is provided, and a self-excited oscillation circuit for generating the resonance voltage is provided at the primary side of the transformer. In this case, there is a tendency that the higher high tension than the power source voltage is produced at the primary side of the transformer, and thus, 2 output can be materialized with the same size of the conventional 1 input 1 output wound-rotor type transformer.

Furthermore, the 1 input 2 output wound-rotor type transformer has a tendency of concentrating the heat generation by the primary coil and the core in the central portion of the transformer but this heat generation is caused in the central portion of the transformer so that the balance of the coupling with the secondary windings is maintained in a preferable condition, and the transformer operates efficiently. Like the conventional 1 input 1 output wound-rotor type transformer, when the heat generation concentrates at the one side of the transformer, the imbalance occurs in the coupling of the primary winding and the secondary windings that obstructs the better efficiency of its operation.

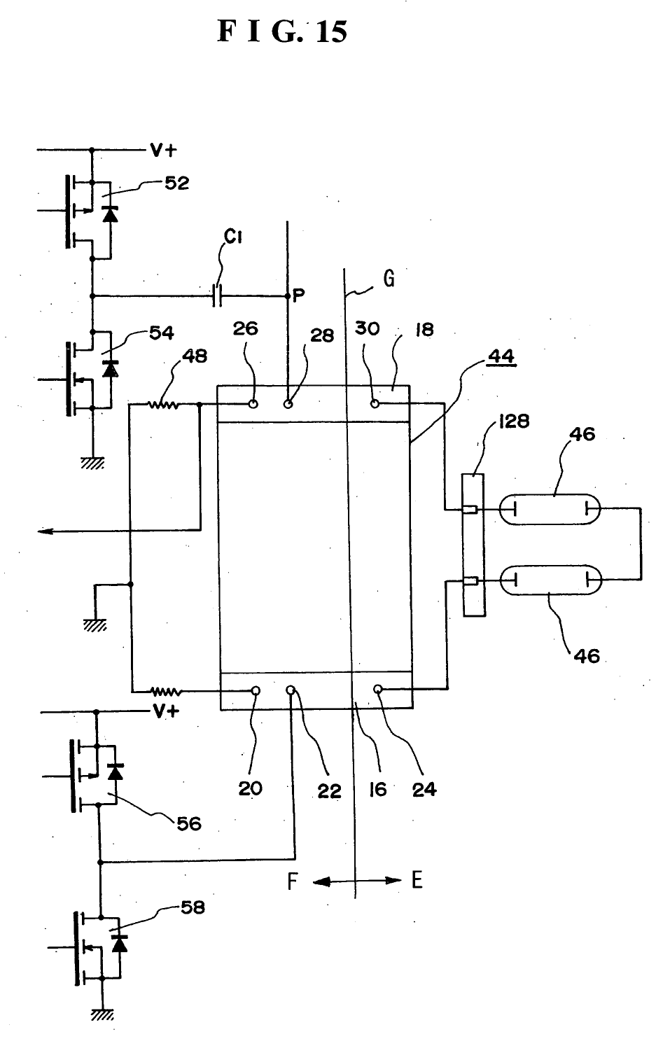

An embodiment shown in FIG. 15 as reference is described in the following wherein the wound-rotor type transformer 44 is operated by a self-excited oscillation circuit that generates the resonance voltage at the primary side of the wound-rotor type transformer. The self-excited oscillation circuit is identical with the circuit shown in FIG. 3, and the self-excited oscillation circuit will be described by referring to a circuit shown in FIG. 3.

In FIG. 15, numerals 52, 54, 56, 58 are switching elements consisting of FET, and commutation diodes 60, 62, 64, 66 are connected between the source and drain of each switching elements. Gate control circuits 68, 70, 72, 74 are connected to each gate of the switching elements 52, 54, 56, 58, and among the gate control circuits, the gate control circuits 68, 72 are connected to a PWM control circuit 76, and the gate control circuits 70, 74 are connected to a logic circuit 78. The PWM control circuit receives signals from a lamp electric current detecting circuit 80 that detects the electric current flowing in the lamps, and controls the continuity angle of the switching elements 52, 56 so that the level of the signals become a set value. The transformer 44 is fixed to the print substrate (drawing is omitted), and two pieces of the cold cathode type fluorescent lamps 46, 46 are connected in series, and each terminal of the fluorescent lamps 46, 46 is respectively connected to the sides of the high tension terminals side of the secondary coils 39, 41 of the wound-rotor type transformer 44. Each terminal of the secondary side windings 39, 41 is earthed by means of the respective resistors.

One resistor 48 constitutes an electric current detecting circuit, and is connected to a lamp open lamp short detecting circuit 90 and a starting compensation circuit 88 by means of the lead wires. The phase detecting circuit 51 is connected to a middle point of a LC series resonance circuit. The logic circuit 78 is constructed so that it creates signals for turning the switching elements ON and OFF on the basis of primary side resonance phase signals from the phase detecting circuit 51 connected to the lead wires 27, and transmits the ON and OFF signals to the gate control circuits 68, 72 by means of the PWM control circuit 76, and transmits the ON, OFF control signals to the gate control circuits 70, 74. The phase detecting circuit 51 transmits the corrected phase signals delayed by 90 degrees from the phase voltage signals of the middle point of the LC series resonance circuit to the logic circuit 78. The signals become the same phase with the electric current flowing in the primary side LC series resonance circuit. The electric current flowing in the primary side series resonance circuit is such that even if the charge voltage of the capacitor C1 reaches the DC power source voltage, the voltage at the primary side terminal of the transformer 44 further lowers beyond OV after passing the phase time of 90 degrees electrically, and becomes a maximum value of the minus after passing the phase time of 90 degrees.

At this time, the signals delayed by 90 degrees from this voltage becomes. OV so that the switching control signals are turned ON and OFF at this timing. The logic circuit 78 outputs alternately the switching control signals. The self-excited oscillation circuit oscillates in self-excitation manner with the primary side resonance frequency of the wound-rotor type transformer 100. There occurs no unevenness in brightness since the high tension of the secondary side winding of the transformer is applied to the electrodes of each terminal of two pieces of the fluorescent lamps 46, 46. Once the wound-rotor type transformer 44 is fixed to the substrate in a proper direction, as shown in FIG. 15, the secondary high tension terminals 24, 30 are disposed in parallel by sandwiching the bobbin (insulator member) 2 at right side of the terminal bases 16, 18 extending in right angle direction relative to the axial direction of the bobbin (insulator member) 2 and the primary input terminals 22, 28 are disposed in parallel by sandwitching the bobbin (insulator member) 2 with the ground terminals 20, 26 at the left side. For this reason, the lamps 46, 46 can be connected to the wound-rotor type transformer 44 by means of the connector 128 at the shortest distance in simple manner, and the connecting wiring between the transformer 44 and the lamps 46, 46 and connecting wiring with the self-excited oscillation circuit can be made extremely in simple structure.

Moreover, as will be obvious from FIG. 15, the high tension terminals are disposed at the right side of the wound-rotor type transformer, and the low tension terminals are disposed at the left side so that an edge surface distance between the high tension side E and the low tension side F of the transformer can be reserved in wide range, and a stable operation of the transformer and a smaller size unit can be materialized.

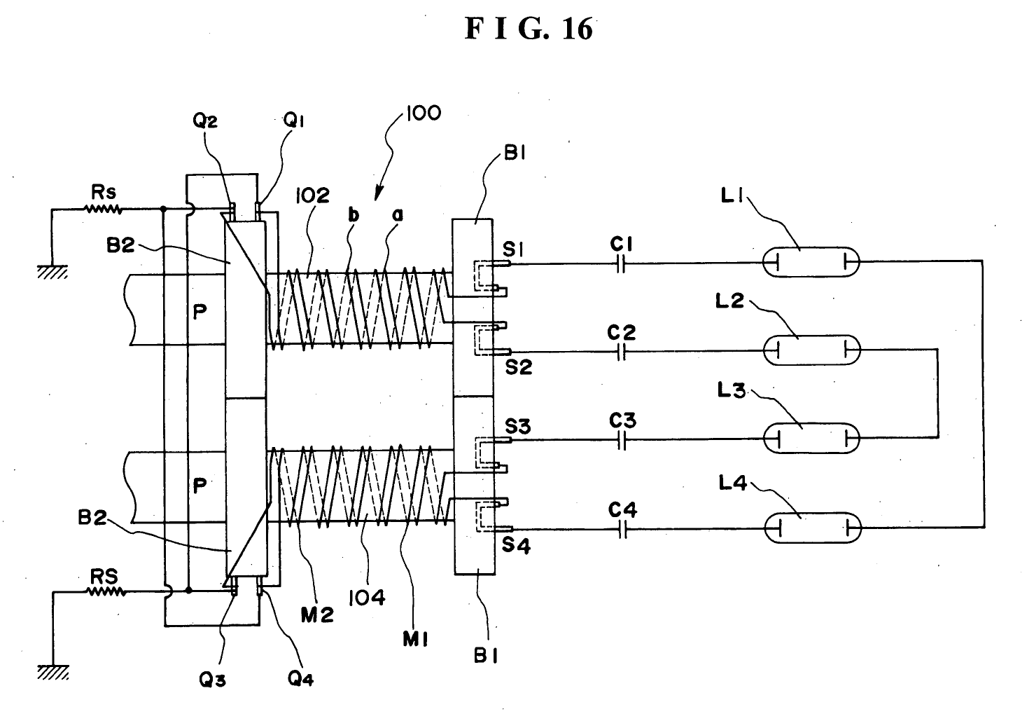

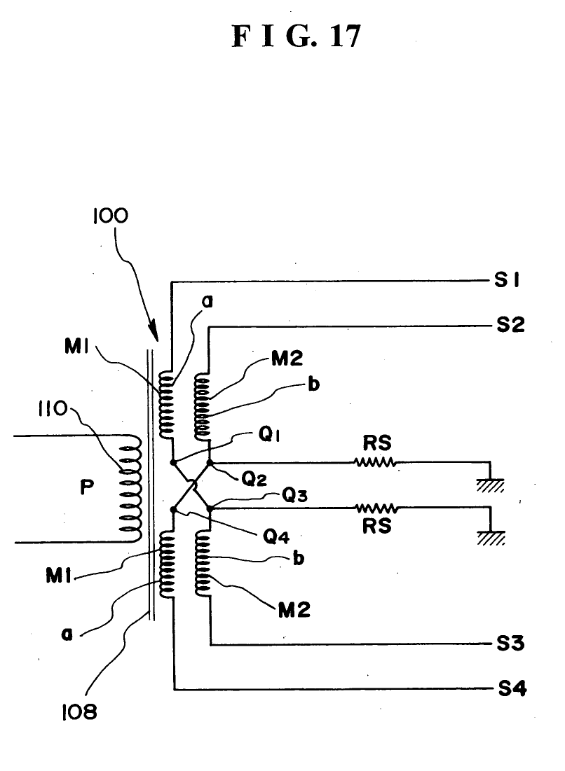

Furthermore, another embodiment of this invention will be described in the following by referring to FIG. 16 and FIG. 17.

Although the wound-rotor type transformer 100 shown in FIG. 16 is almost identical with the transformer 100 shown in FIG. 4, two pieces of terminals Q1, Q2 ad Q3, Q4 are provided for each bobbin 102, 104 on the terminal board B2 as illustrated in FIG. 16. As illustrated in FIG. 17, terminals of the secondary winding M1 at the bobbins 102, 104 sides are respectively connected to the terminals Q2 and Q3. The terminals Q2, Q4 are respectively and mutually earthed by means of the resistors Rs. The terminals Q1, Q3 are similarly and mutually connected and earthed respectively by means of the resistors. A lamp drive circuit is provided with a piece of closed loop electric current path by the foregoing wiring connecting the terminal S1, lamp L1, lamp L4, terminal S4, terminal Q4, terminal Q2, terminal S2, lamp L2, lamp L3, terminal Q3, terminal Q1 and returning to the terminal S1 with assumption that the terminal S1 is starting point, and the identical electric current flows in the lamps L1-L4, and the brightness of each lamp becomes uniform.

1. A wound-rotor type transformer provided with a primary winding and a secondary winding on a bobbin inserted with a core, an improved wound-rotor transformer wherein a terminal base is provided at the side where a high tension terminal of the bobbin is disposed, and the first terminal connected to one end of the secondary winding is mounted on the terminal base at the side where the high tension terminal is disposed and the second terminal connected to the other end of the second winding is mounted at the side where a low tension terminal of rearward at a distance against the side where the high tension terminal of the bobbin is disposed, and the second terminal is used for a ground terminal.

2. A wound-rotor type transformer according to claim 1 wherein the high tension terminal disposed side of the bobbin is the side of one end of the secondary winding in its axial direction which is cylindrically wound, and the low tension terminal disposed side is the other end of the secondary winding in its axial direction.

3. A wound-rotor type transformer according to claim 1, wherein two pieces of the bobbins are integrally joined in parallel, and the primary winding and the secondary winding are mounted respectively on the two pieces of the bobbins in series, and an input terminal connected to the primary winding is mounted on the terminal base at the side of the other end of each of the bobbins, and the first terminal connected to the one end of each of the secondary windings of each of the bobbins is mounted on the terminal base mounted on the one end of each of the bobbins, and the second terminal connected to the other end of each of the secondary windings of each of the bobbins is mounted on the terminal base mounted on a border part of the primary winding and the secondary winding, and one end of the bobbin is made as the side where the high tension terminal is disposed, and the border part of the secondary winding and the primary winding is made as the side where the low tension terminal is disposed.

4. A wound-rotor type transformer according to claim 3, wherein the secondary windings mounted on the two pieces of the bobbins are wound mutually in counter direction with the same number of windings, and the first terminal and the second terminal mounted at the side where the high tension terminal is disposed become the counter phase.

5. A wound-rotor type transformer according to claim 1, wherein the secondary windings consist of a plurality of wires which are arranged in parallel, and the first terminals are respectively connected to each end of the wires, and the second terminals are respectively connected to each end of each of the wires.

6. A power source device for driving lamps with high tension outputs at the secondary of the wound-rotor type transformer wherein the primary windings and the secondary windings are mounted on the bobbins inserted with the cores, and the terminal base is provided at the side where the high tension terminals of the bobbins are provided, and the first terminals connected to the one end of each of the secondary windings are mounted on the terminal base at the side where the high tension terminals are disposed, and the second terminals connected to the other terminals of the secondary windings mounted on the bobbins are mounted at the side where the low tension terminals of rearward relative to the side where the high tension terminals of the bobbins are disposed at a predetermined distance, and the second terminals are made as the ground terminals, an improved power source device wherein the primary windings are connected to an AC signal output circuit, and the second terminals are earthed, and the first terminals are connected to the lamps.

7. A power source device for driving the lamps with the high tension output of the secondary side of the wound-rotor type transformer wherein the primary windings and the secondary windings are mounted on the bobbins inserted with the cores, and the terminal base is provided at the side where the high tension terminals of the bobbins are disposed, and the first terminals connected to the one terminals of the secondary windings are mounted on the terminal base at the side where the high tension terminals are disposed, and the second terminals connected to the other terminals of the secondary windings mounted on the bobbins are mounted at the side where the low tension terminals of rearward relative to the side where the high tension terminals of the bobbins are disposed at a predetermined distance, and the second terminals are made as the ground terminals, and the side where the high tension terminals of the bobbins are disposed is the one end side of the other terminals of the secondary windings in its axial direction which are cylindrically wound, and the side where the low tension terminals are disposed is the other terminals of the secondary windings, an improved power source device wherein the primary windings are connected to the AC signal output circuit, ad the second terminals are earthed, and the first terminals are connected to the lamps.

8. A power source device for driving the lamps with the high tension output at the secondary side of the wound-rotor type transformer, an improved power source device wherein two pieces of the bobbins inserted with the cores are arranged in parallel to be integrally joined, and the primary windings and the secondary windings are serially mounted on the two pieces of the bobbin, and the input terminals connected to the primary windings are mounted on the terminal base at the side of the other end of the each bobbin, and the first terminals connected to the one terminal of each of the secondary windings of each of the bobbins are mounted on the terminal base that is mounted on the one end of each of the bobbins, and the second terminals connected to the other terminals of each of the secondary windings of each of the bobbins are mounted on the terminal base provided on the border part of the primary windings and the secondary windings, and the second terminals are made as the ground terminals, and the one ends of the bobbins are made as the high tension terminal disposed side, and the border part of the secondary windings and the primary windings are made as the low tension terminal disposed side, an improved power source device wherein the primary windings are connected to the AC signal output circuit, and the second terminals are earthed, and the first terminals are connected to the lamps.

9. A power source device for driving the lamps with the high tension output at the secondary side of the wound-rotor type transformer, an improved power source device wherein two pieces of the bobbins inserted with the cores are arranged in parallel to be integrally joined, and the primary windings and the secondary windings are serially mounted on the two pieces of the bobbin, and the input terminals connected to the primary windings are mounted on the terminal base at the side of the other end of the each bobbin, and the first terminals connected to the one terminal of each of the secondary windings of each of the bobbins are mounted on the terminal base that is mounted on the one end of each of the bobbins, and the second terminals connected to the other terminals of each of the secondary windings of each of the bobbins are mounted on the terminal base provided on the border part of the primary windings and the secondary windings, and the second terminals are made as the ground terminals, and the one ends of the bobbins are made as the high tension terminal disposed side, and the border part of the secondary windings and the primary windings are made as the low tension terminal disposed side, and the secondary windings mounted on the two pieces of the bobbins are wound mutually in counter direction with the same number of windings, and the first terminals and the second terminals mounted at the high tension terminal disposed side become in counter phase, an improved power source device wherein the primary windings are connected to the AC signal output circuit and the second terminals are earthed, and the first terminals are connected to the lamps.

10. A power source device according to claim 6, wherein the secondary windings of the wound-rotor type transformer are formed with a plurality of wires arranged in parallel, and the first terminals are respectively connected to each end of the wires, and the second terminals are respectively connected to the other ends of each of the wires.

11. A power source device according to claim 6, wherein the wound-rotor transformer and a circuit for inputting AC signals to the transformer are mounted on a printed-circuit board, and connectors connected to the lamps are mounted on the printed-circuit board, and the high tension terminal disposed side of the wound-rotor type transformer is disposed in opposition to the connectors, and the first terminals are connected to the connectors.
